(19) United States
(12) Patent Application Publication
(10) Pub. No.: US 2025/0187677 A1
(43) Pub. Date: Jun. 12, 2025

(54) JOINT STRUCTURE OF VEHICLE BODY

(71) Applicants: HYUNDAI MOTOR COMPANY, Seoul (KR); Kia Corporation, Seoul (KR)

(72) Inventors: Jaeha SHIM, Hwaseong-si (KR); Hyung Tae KIM, Hwaseong-si (KR); SunKi CHOI, Hwaseong-si (KR); Youngho LEE, Hwaseong-si (KR); Daemyoung PARK, Hwaseong-si (KR)

(73) Assignees: HYUNDAI MOTOR COMPANY, Seoul (KR); Kia Corporation, Seoul (KR)

(21) Appl. No.: 18/944,798

(22) Filed: Nov. 12, 2024

(30) Foreign Application Priority Data
Dec. 8, 2023 (KR) 10-2023-0177518

(51) Int. Cl. B62D 27/06; B62D 25/20

(52) U.S. Cl. CPC B62D 27/065; B62D 25/2018; B62D 25/2027

(57) ABSTRACT

A joint structure of a vehicle body includes a front body module as a fixed portion fixed to a front portion of an under body, a rear body module as a variable portion detachable to a rear portion of the under body and the front body module in a predetermined shape, a roof joint unit made of an aluminum extruding member and connecting a fixed portion roof structure of the front body module and a variable portion roof structure of the rear body module, and a floor joint unit made of an aluminum extruding member and connecting a fixed portion floor structure of the front body module and a variable portion floor structure of the rear body module.

### CROSS-REFERENCE TO RELATED APPLICATION

The present application claims priority to Korean Patent Application No. 10-2023-0177518 filed on Dec. 8, 2023, the entire contents of which is incorporated herein for all purposes by this reference.

### BACKGROUND OF THE PRESENT DISCLOSURE

### Field of the Present Disclosure

The present disclosure relates to a vehicle body. More particularly, the present disclosure relates to a joint structure which may be applied to the production of various body types.

### Description of Related Art

Recently, the vehicle industry is introducing a new concept of future mobility vision for realizing a human-centered, dynamic future city. One of these future mobility solutions is a Purpose Built Vehicle (PBV) as purpose-based mobility.

A PBV may be an example of an electric vehicle (EV)-based environment-friendly mobile vehicle. The present PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of PBV. For example, the PBV may be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage compartment is configured in the rear part.

PBV can only be used as a hailing or delivery vehicle, but if users can change its purpose, the vehicle's usage time can increase significantly.

In other words, if the vehicle's purpose may be easily changed, the front cabin of the vehicle, including the driver's seat of the upper body, and the underbody are made of a common configuration, and if the rear of the upper body is configured to be easily replaceable, the vehicle usability may be increased while reducing costs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a joint structure of a vehicle body which may be easily changed into various types of vehicle bodies to increase the usability of the PBV.

A joint structure of a vehicle body according to various exemplary embodiments of the present disclosure may include a front body module as a fixed portion fixed to a front portion of an under body, a rear body module as a variable portion detachable to a rear portion of the under body and the front body module in a predetermined shape, a roof joint unit made of an aluminum extruding member to connect a fixed portion roof structure of the front body module and a variable portion roof structure of the rear body module, and a floor joint unit made of an aluminum extruding member to connect a fixed portion floor structure of the front body module and a variable portion floor structure of the rear body module.

The roof joint unit may include a fixed portion roof joint extruding member that engages with a fixed portion roof rail and a fixed portion roof panel of the fixed portion roof structure connected to each other, and a variable portion roof joint extruding member that engages with a variable portion roof rail and a variable portion roof panel of the variable portion roof structure connected to each, and is connected to the fixed portion roof joint extruding member.

The fixed portion roof joint extruding member may include a fixed portion center joint section engaged with the fixed portion roof panel, a fixed portion front joint section extending forward from the fixed portion center joint section and engaged with the fixed portion roof rail, and a fixed portion rear joint section extending rearward from the fixed portion center joint section and engaged with the variable portion roof joint extruding member.

The fixed portion roof joint extruding member may further include a fixed portion molding joint rib formed on the fixed portion center joint section.

The fixed portion roof joint extruding member may further include a fixed portion reinforcement rib formed on the fixed portion rear joint section.

The variable portion roof joint extruding member may include a variable portion center joint section engaged with the variable portion roof panel, a variable portion rear joint section extending rearward from the variable portion center joint section and engaged with the variable portion roof rail, and a variable portion front joint section extending forward from the variable portion center joint section and engaged with the fixed portion rear joint section.

The variable portion roof joint extruding member may further include a variable portion molding joint rib formed on the variable portion center joint section.

The variable portion roof joint extruding member may further include a variable portion reinforcement rib formed on the variable portion front joint section.

A first gap may be formed between the fixed portion center joint section and the variable portion front joint section;

A second gap may be formed between the fixed portion rear joint section and the variable portion reinforcement rib.

A roof molding member may be connected to the fixed portion roof joint extruding member and the variable portion roof joint extruding member.

The roof molding member may be connected to a fixed portion molding joint rib formed on the fixed portion roof joint extruding member and a variable portion molding joint rib formed on the variable portion roof joint extruding member through a watertight pad.

The floor joint unit may include a fixed portion floor joint extruding member engaged with a fixed portion floor panel of the fixed portion floor structure, and a variable portion floor joint extruding member engaged with a variable portion floor panel of the variable portion floor structure and engaged with the fixed portion floor joint extruding member.

The fixed portion floor joint extruding member may include a first engaging portion that engages with the fixed portion floor panel and forms a fixed portion closed cross-section, and a second engaging portion which extends rearward from the first engaging portion and engages with the variable portion floor joint extruding member.

The variable portion floor joint extruding member may include a third engaging portion that engages with the variable portion floor panel and forms a variable portion closed cross-section, and a fourth engaging portion that extends forward from the third engaging portion and engages with the second engaging portion.

A third gap may be formed between the first engaging portion and the fourth engaging portion, and a fourth gap may be formed between the second engaging portion and the third engaging portion.

A joint structure of a vehicle body according to various exemplary embodiments of the present disclosure may include a front body module as a fixed portion fixed to a front portion of an under body, a rear body module as a variable portion detachable to a rear portion of the under body and the front body module in a predetermined shape, a roof joint unit connecting a fixed portion roof structure of the front body module and a variable portion roof structure of the rear body module, a floor joint unit connecting a fixed portion floor structure of the front body module and a variable portion floor structure of the rear body module, and a side joint unit made of an aluminum extruding member and connecting a fixed portion pillar assembly of the front body module and a variable portion pillar structure of the rear body module.

The side joint unit may include a side internal joint extruding member engaged with a side external joint member of steel material connecting the external sides of the fixed portion pillar assembly and the variable portion pillar assembly, and connecting the internal sides of the fixed portion pillar assembly and the variable portion pillar assembly.

The side internal joint extruding member may include a center engaging portion engaged with the side external joint member, a front engaging portion extending forward from the center engaging portion and engaged with a fixed portion internal pillar member of the fixed portion pillar assembly, and a rear engaging portion extending rearward from the center engaging portion and engaged with a variable portion internal pillar member of the variable portion pillar assembly.

A weather strip may be mounted between a fixed portion external pillar member of the fixed portion pillar assembly and the side external joint member, and between a variable portion external pillar member of the variable portion pillar assembly and the side external joint member.

A fixed portion internal pillar member of the fixed portion pillar assembly and a fixed portion roof rail of the fixed portion roof structure may be connected through a fixed portion gusset member.

A variable portion internal pillar member of the variable portion pillar assembly and a variable portion roof rail of the variable portion roof structure may be connected through a variable portion gusset member.

According to the joint structure of a vehicle body according to exemplary embodiments of the present disclosure, the PBV may be easily changed into various types of vehicle bodies to increase the usability of the PBV and reduce the manufacturing cost of the PBV.

Furthermore, effects which may be obtained or expected due to various exemplary embodiments of the present disclosure will be included directly or implicitly in the detailed description of the present disclosure. That is, various effects expected according to exemplary embodiments of the present disclosure will be included in the detailed description to be described later.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing a joint structure of a vehicle body according to an exemplary embodiment of the present disclosure.

FIG. 2, FIG. 3 and FIG. 4 are partially cut-away perspective views exemplarily illustrating the joint structure of a vehicle body according to an exemplary embodiment of the present disclosure.

FIG. 5 is a perspective view exemplarily illustrating a roof joint unit applied to the joint structure of a vehicle body according to an exemplary embodiment of the present disclosure.

FIG. 6 is a cross-sectional view exemplarily illustrating the roof joint unit applied to the joint structure of a vehicle body according to an exemplary embodiment of the present disclosure.

FIG. 7 is a perspective view exemplarily illustrating a floor joint unit applied to the joint structure of a vehicle body according to an exemplary embodiment of the present disclosure.

FIG. 8 is a cross-sectional view exemplarily illustrating the floor joint unit applied to the joint structure of a vehicle body according to an exemplary embodiment of the present disclosure.

FIG. 9 and FIG. 10 are perspective views exemplarily illustrating a side joint unit applied to the joint structure of a vehicle body according to an exemplary embodiment of the present disclosure.

FIG. 11 is a cross-sectional view exemplarily illustrating the side joint unit applied to the joint structure of a vehicle body according to an exemplary embodiment of the present disclosure.

FIG. 12 is a drawing showing a reinforcing unit applied to the joint structure of a vehicle body according to an exemplary embodiment of the present disclosure.

FIG. 13 is a drawing for explaining the assembly process of the joint structure of a vehicle body according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the appended drawings, various exemplary embodiments of the present disclosure will be described in detail so that those skilled in the art can easily implement the present disclosure. As those skilled in the art would realize, the described embodiments may be modified in various different ways, all without departing from the spirit or scope of the present disclosure.

The terminology used herein is for describing specific disclosures only and is not intended to limit the present disclosure. As used herein, singular forms are intended to also include plural forms, unless the context clearly indicates otherwise.

Furthermore, in the detailed description below, the names of the components are divided into first, second, etc. to distinguish them when the components are in a similar relationship, and the description below is not necessarily limited to that order.

As used herein, the terms ‘comprise’ and/or ‘comprising’ indicate the presence of specified features, integers, steps, operations, elements and/or components, but may also include one or more other features, integers or steps. It should also be understood that this does not exclude the presence or addition of elements, operations, components, and/or groups thereof.

As used herein, the term ‘and/or’ includes any one or all combinations of one or more items listed in association.

In the present specification, the term ‘connected’ indicates a physical relationship between two components in which the components are directly connected to each other by welding, rivets, Self Piercing Rivet (SPR), Flow Drill Screw (FDS), structural adhesive, etc., or indirectly connected through one or more intermediate components.

As used herein, ‘vehicle’, ‘vehicular’, ‘automotive’ or other similar terms as used herein generally refer to passenger vehicles, sports cars, sports utility vehicles (SUVs), buses, trucks, and various commercial vehicles including passenger automobiles, hybrid vehicles, electric vehicles, hybrid electric vehicles, electric vehicle-based Purpose built vehicles (PBVs), hydrogen-powered vehicles and other alternative fuel vehicles (e.g., other than petroleum fuel derived from resources).

Hereinafter, disclosures of the present disclosure will be described in detail with reference to the accompanying drawings.

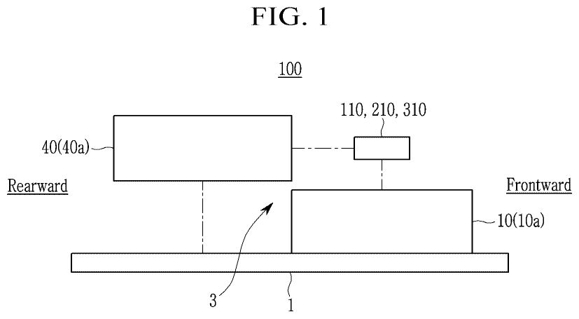

FIG. 1 is a block diagram showing a joint structure of a vehicle body according to an exemplary embodiment of the present disclosure.

Referring to FIG. 1, a vehicle body to which a joint structure 100 of a vehicle body according to an exemplary embodiment of the present disclosure may be applied may be, for example, a purpose-based mobility vehicle (Purpose Built Vehicle: hereinafter referred to as ‘PBV’).

The PBV may be utilized as an electric car-based life module vehicle that provides various customized services to users during the time it takes to move from the departure point to the destination.

As an exemplary embodiment of the present disclosure, the PBV may be manufactured as a 1 box type design with a wide internal space. Furthermore, the PBV may have facing-type seats applied to the internal space.

The vehicle body of the present PBV is suitable for small-quantity production of various vehicle types with a small number of parts, and may be manufactured in various shapes and sizes.

Furthermore, the vehicle body of the PBV includes a skateboard type under body 1, (which is also commonly referred to as a ‘rolling chassis’ or ‘chassis frame’ by those skilled in the art) and an upper body 3 assembled to the under body 1.

The under body 1 can accommodate components such as a battery assembly and a drive motor. The upper body 3 is a Body In White (BIW) body which is connected to the under body 1 and may include a cabin and luggage compartment with a wide internal space.

In the present specification, the ‘front-to-back direction of the vehicle body’ may be defined as the longitudinal direction of the vehicle body, the ‘vehicle width direction’ may be defined as the left and right direction of the vehicle body, and the ‘up-and-down direction’ may be defined as the height direction of the vehicle body.

Furthermore, in the present specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in the present specification, an end portion of a component (e.g., one end portion or another (other) end portion, etc.) denotes an end portion of a component in any one direction, and an end portion of the component (e.g., one end portion) or other (another) end portion, etc.) denotes a portion of a component that includes that end.

The joint structure 100 of a vehicle body according to an exemplary embodiment of the present disclosure is a structure which may apply the upper body 3 of various shapes and purposes to the under body 1 according to the type of customized service of the PBV.

The joint structure 100 of a vehicle body according to an exemplary embodiment of the present disclosure includes the upper body 3 assembled to the under body 1, and including a front body module 10 and a rear body module 40.

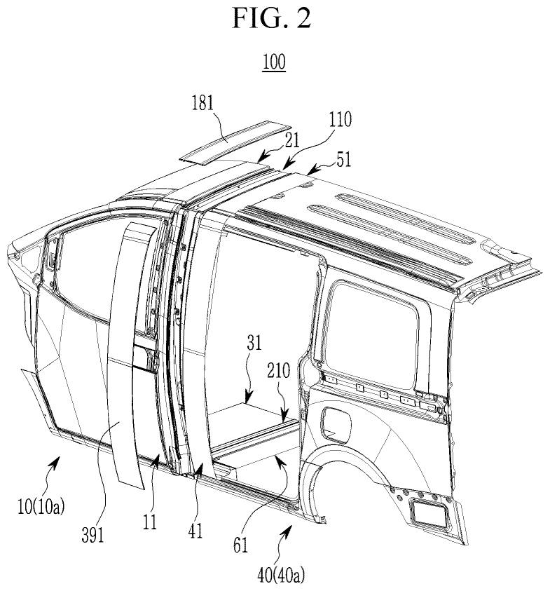

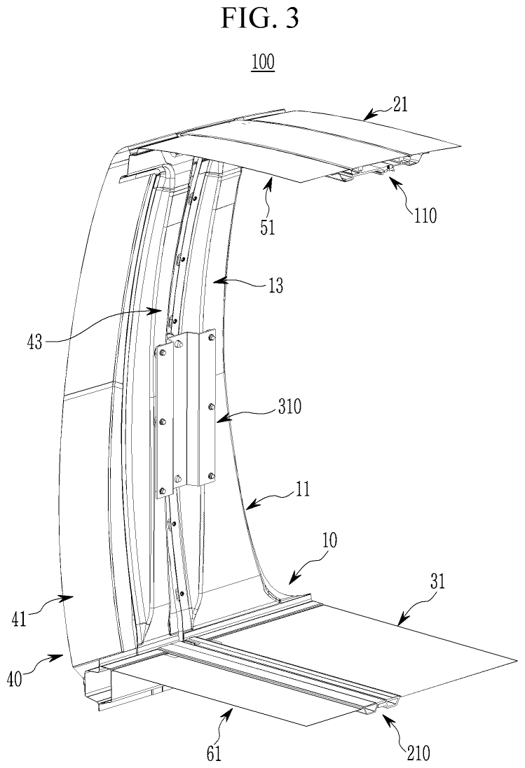

FIG. 2, FIG. 3 and FIG. 4 are partially cut-away perspective views exemplarily illustrating the joint structure of a vehicle body according to an exemplary embodiment of the present disclosure.

FIG. 2, FIG. 3 and FIG. 4 illustrate only one side of the vehicle body, the rear portion of the front body module 10, and the front portion of the rear body module 40.

Referring to FIG. 1, FIG. 2, FIG. 3 and FIG. 4, in an exemplary embodiment of the present disclosure, the front body module 10 includes a front cabin of a cab type. The front body module 10 may be fixed to the front portion of the under body 1.

The front body module 10 may be mounted to the front portion of the under body 1 along the vertical direction via a vehicle body mounting unit known to a person of ordinary skill in the art. The front body module 10 may be a fixed portion (fixed portion) 10a fixed to the front portion of the under body 1. The fixed portion 10a is a component connected to the underbody 1 and is defined in an exemplary embodiment and claims as a component which is not to be replaced even if the intended use of the vehicle changes.

The front body module 10 includes a fixed portion side structure 11, a fixed portion roof structure 21, and a fixed portion floor structure 31, which are connected to each other.

The fixed portion side structure 11 is provided on each side of the front body module 10 in the vehicle width direction. The fixed portion roof structure 21 connects the upper portion of the fixed portion side structures 11 along the vehicle width direction. The fixed portion floor structure 31 connects the lower portion of the fixed portion side structures 11 along the vehicle width direction.

In an exemplary embodiment of the present disclosure, the rear body module 40 includes a rear cabin or luggage compartment. The rear body module 40 may be mounted to the rear portion of the under body 1.

The rear body module 40 may be mounted to the rear portion of the under body 1 via a vehicle body mounting unit known to a person of ordinary skill in the art. The rear body module 40 is a component which may be replaced (or detached) depending on the vehicle's intended use, and is defined as a variable portion (replaceable portion) 40a in an exemplary embodiment and claims.

The rear body module 40 includes a variable portion side structure 41, a variable portion roof structure 51, and a variable portion floor structure 61, which are connected to each other.

The variable portion side structure 41 is provided on each side of the rear body module 40 in the vehicle width direction. The variable portion roof structure 51 connects the upper portion of the variable portion side structures 41 along the vehicle width direction. The variable portion floor structure 61 connects the lower portion of the variable portion side structures 41 along the vehicle width direction.

The joint structure 100 of a vehicle body according to an exemplary embodiment of the present disclosure provides a structure which may be commonly applied to various vehicle types. Various vehicle types means various configurations of variable portion 40a, and can be, for example, a hailing vehicle as a means of transporting occupants, a delivery vehicle for transporting goods, and special vehicles such as ambulances.

The joint structure 100 according to various exemplary embodiments of the present disclosure includes a roof joint unit 110, a floor joint unit 210, and a side joint unit 310 that are configured to connect the front body module 10 and the rear body module 40 in the front-to-back direction of the vehicle body.

The roof joint unit 110 is configured to connect the fixed portion roof structure 21 of the front body module 10 and the variable portion roof structure 51 of the rear body module 40 along the front-to-back direction of the vehicle body.

The roof joint unit 110 may be manufactured as an aluminum extruding member formed by an aluminum extrusion molding method.

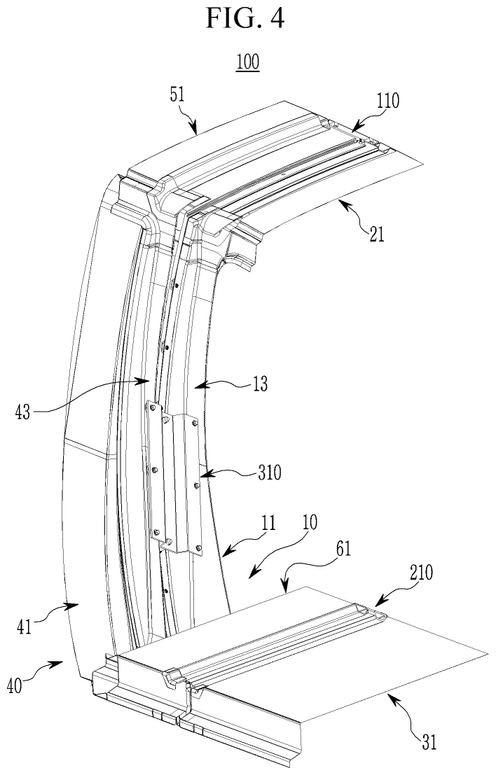

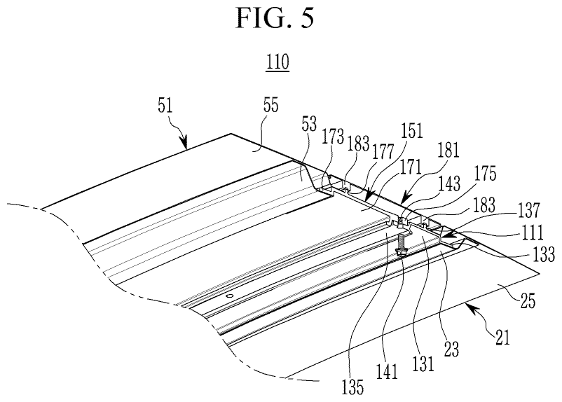

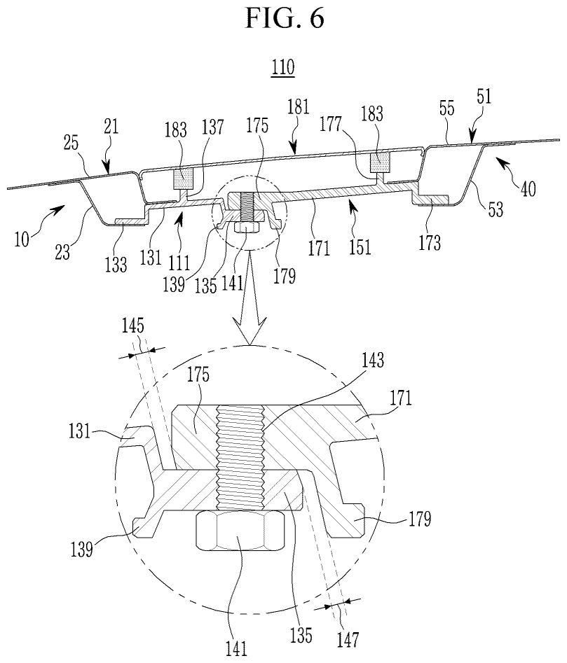

FIG. 5 is a perspective view exemplarily illustrating a roof joint unit applied to the joint structure of a vehicle body according to an exemplary embodiment of the present disclosure, and FIG. 6 is a cross-sectional view exemplarily illustrating the roof joint unit applied to the joint structure of a vehicle body according to an exemplary embodiment of the present disclosure.

Referring to FIG. 5 and FIG. 6, the roof joint unit 110 includes a fixed portion roof joint extruding member 111 and a variable portion roof joint extruding member 151.

The fixed portion roof joint extruding member 111 engages with a fixed portion roof rail 23 and a fixed portion roof panel 25 of the fixed portion roof structure 21 that are connected to each other.

The fixed portion roof joint extruding member 111 is disposed along the vehicle width direction parallel to the fixed portion roof rail 23. The fixed portion roof joint extruding member 111 is provided as an aluminum extruding member and may be provided in a plate shape.

The fixed portion roof joint extruding member 111 includes a fixed portion center joint section 131, a fixed portion front joint section 133, and a fixed portion rear joint section 135.

The fixed portion center joint section 131 engages with the fixed portion roof panel 25. The fixed portion center joint section 131 and the fixed portion roof panel 25 may be engaged by a mechanical junction method, such as a junction method using a self-piercing rivet (SPR), a flow drill screw (FDS), or a blind rivet.

The fixed portion front joint section 133 extends forward from the fixed portion center joint section 131 and engages with the fixed portion roof rail 23. The fixed portion front joint section 133 and the fixed portion roof rail 23 may be engaged by the mechanical junction method mentioned above.

The fixed portion rear joint section 135 extends rearward from the fixed portion center joint section 131 and engages with a variable portion roof joint extruding member 151, which will be described later.

The fixed portion roof joint extruding member 111 further includes a fixed portion molding joint rib 137 formed on the fixed portion center joint section 131.

The fixed portion molding joint rib 137 extends upwards from the upper portion of the fixed portion center joint section 131 and is disposed in the longitudinal direction (or vehicle width direction) of the fixed portion roof joint extruding member 111.

The fixed portion roof joint extruding member 111 further includes a fixed portion reinforcement rib 139 formed on the fixed portion rear joint section 135.

The fixed portion reinforcement rib 139 is configured to reinforce the strength of the fixed portion roof joint extruding member 111. The fixed portion reinforcement rib 139 extends downwardly from the lower portion of the fixed portion rear joint section 135 and is disposed in the longitudinal direction (or vehicle width direction) of the fixed portion roof joint extruding member 111.

The variable portion roof joint extruding member 151 engages with a variable portion roof rail 53 and a variable portion roof panel 55 of the variable portion roof structure 51 that are connected to each other, and engages with the fixed portion roof joint extruding member 111.

The variable portion roof joint extruding member 151 is disposed along the vehicle width direction parallel to the variable portion roof rail 53. The variable portion roof joint extruding member 151 may be provided as an aluminum extruding member and may be provided in a plate shape.

The variable portion roof joint extruding member 151 includes a variable portion center joint section 171, a variable portion rear joint section 173, and a variable portion front joint section 175.

The variable portion center joint section 171 engages with the variable portion roof panel 55. The variable portion center joint section 171 and the variable portion roof panel 55 may be engaged by the mechanical junction method mentioned above.

The variable portion rear joint section 173 extends rearward from the variable portion center joint section 171 and engages with the variable portion roof rail 53. The variable portion rear joint section 173 and the variable portion roof rail 53 may be engaged by the mechanical junction method mentioned above.

The variable portion front joint section 175 extends forward from the variable portion center joint section 171 and engages with the fixed portion rear joint section 135 of the fixed portion roof joint extruding member 111.

The variable portion front joint section 175 is mounted above the fixed portion rear joint section 135. The variable portion front joint section 175 and the fixed portion rear joint section 135 may be engaged by an engaging bolt 141.

The engage bolt 141 may penetrate the fixed portion rear joint section 135 and engage with a tapping hole 143 formed in the variable portion front joint section 175. The tapping hole 143 is defined as a bolt engage hole with threads formed on the internal surface.

The variable portion roof joint extruding member 151 further includes a variable portion molding joint rib 177 formed on the variable portion center joint section 171.

The variable portion molding joint rib 177 extends upwards from the upper portion of the variable portion center joint section 171 and is disposed in the longitudinal direction (or vehicle width direction) of the variable portion roof joint extruding member 151.

The variable portion roof joint extruding member 151 further includes a variable portion reinforcement rib 179 formed on the variable portion front joint section 175.

The variable portion reinforcement rib 179 is configured to reinforce the strength of the variable portion roof joint extruding member 151. The variable portion reinforcement rib 179 extends downwardly from the lower portion of the variable portion front joint section 175 and is disposed in the longitudinal direction (or vehicle width direction) of the variable portion roof joint extruding member 151.

A first gap 145 is formed between the fixed portion center joint section 131 of the fixed portion roof joint extruding member 111 and the variable portion front joint section 175 of the variable portion roof joint extruding member 151.

A second gap 147 is formed between the fixed portion rear joint section 135 of the fixed portion roof joint extruding member 111 and the variable portion reinforcement rib 179 of the variable portion roof joint extruding member 151.

The first gap 145 and the second gap 147 enable the variable portion front joint section 175 to be easily loaded on the fixed portion rear joint section 135.

The first gap 145 may be formed at a predetermined angle by chamfering the variable portion front joint section 175, and the second gap 147 may be formed at a predetermined angle by chamfering the fixed portion rear joint section 135.

The joint structure 100 of a vehicle body further includes a roof molding member 181.

The roof molding member 181 is configured to seal between the fixed portion roof structure 21 of the front body module 10 and the variable portion roof structure 51 of the rear body module 40.

The roof molding member 181 is connected to the fixed portion roof joint extruding member 111 and the variable portion roof joint extruding member 151.

The roof molding member 181 is connected to the fixed portion molding joint rib 137 and the variable portion molding joint rib 177.

The roof molding member 181 is connected to the fixed portion molding joint rib 137 and the variable portion molding joint rib 177 through a watertight pad 183.

Accordingly, the fixed portion molding joint rib 137, the variable portion molding joint rib 177, and the watertight pad 183 can block water from flowing between the fixed portion roof panel 25 and the roof molding member 181, and between the variable portion roof panel 55 and the roof molding member 181.

That is, the fixed portion molding joint rib 137, the variable portion molding joint rib 177, and the watertight pad 183 can prevent water from penetrating between the fixed portion roof joint extruding member 111 and the variable portion roof joint extruding member 151.

Referring to FIG. 2, FIG. 3 and FIG. 4, in an exemplary embodiment of the present disclosure, the floor joint unit 210 is configured to connect the fixed portion floor structure 31 of the front body module 10 and the variable portion floor structure 61 of the rear body module 40 along the front-to-back direction of the vehicle body.

The floor joint unit 210 may be manufactured as an aluminum extruding member formed by an aluminum extrusion molding method.

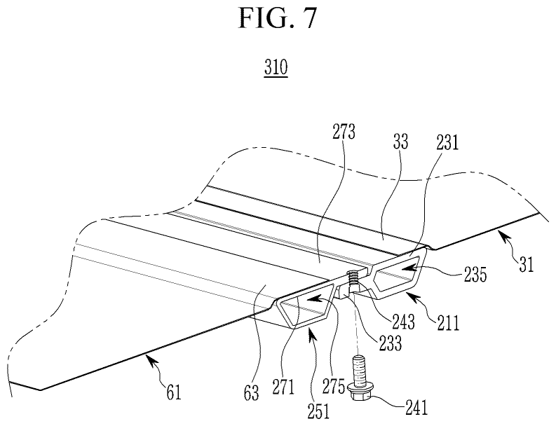

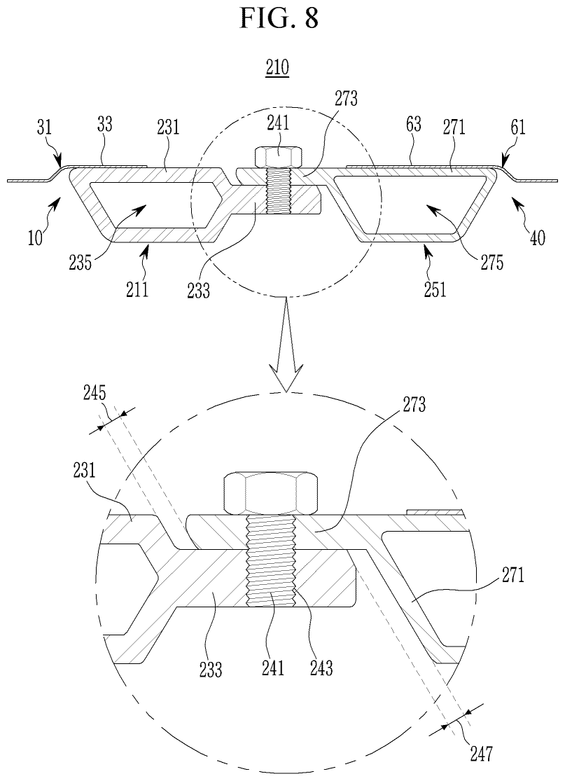

FIG. 7 is a perspective view exemplarily illustrating a floor joint unit applied to the joint structure of a vehicle body according to an exemplary embodiment of the present disclosure, and FIG. 8 is a cross-sectional view exemplarily illustrating the floor joint unit applied to the joint structure of a vehicle body according to an exemplary embodiment of the present disclosure.

Referring to FIG. 7 and FIG. 8, the floor joint unit 210 according to an exemplary embodiment of the present disclosure includes a fixed portion floor joint extruding member 211 and a variable portion floor joint extruding member 251.

The fixed portion floor joint extruding member 211 engages with the fixed portion floor panel 33 of the fixed portion floor structure 31. In one example, the fixed portion floor joint extruding member 211 is provided as an aluminum extruding member and may be provided in a plate shape.

The fixed portion floor joint extruding member 211 includes a first engaging portion 231 and a second engaging portion 233.

The first engaging portion 231 engages with the fixed portion floor panel 33. The first engaging portion 231 includes a fixed portion closed cross-section 235 of a predetermined shape. The first engaging portion 231 and the fixed portion floor panel 33 may be engaged by the mechanical junction method mentioned above.

The second engaging portion 233 extends rearward from the first engaging portion 231 and engages with the variable portion floor joint extruding member 251.

The variable portion floor joint extruding member 251 engages with the variable portion floor panel 63 of the variable portion floor structure 61 and engages with the fixed portion floor joint extruding member 211.

The variable portion floor joint extruding member 251 is disposed along the vehicle width direction parallel to the fixed portion floor joint extruding member 211. In one example, the variable portion floor joint extruding member 251 is provided as an aluminum extruding member and may be provided in a plate shape.

This variable portion floor joint extruding member 251 includes a third engaging portion 271 and a fourth engaging portion 273.

The third engaging portion 271 engages with the variable portion floor panel 63. The third engaging portion 271 includes a variable portion closed cross-section 275 of a predetermined shape. The third engaging portion 271 and the variable portion floor panel 63 may be engaged by the mechanical junction method mentioned above.

The fourth engaging portion 273 extends forward from the third engaging portion 271 and engages with the second engaging portion 233 of the fixed portion floor joint extruding member 211.

The fourth engaging portion 273 is disposed on the second engaging portion 233. The fourth engaging portion 273 and the second engaging portion 233 may be engaged by an engage bolt 241.

The engaging bolt 241 may pass through the fourth engaging portion 273 and engage with a tapping hole 243 formed in the second engaging portion 233. The tapping hole 243 is defined as a bolt engage hole including threads formed on the internal surface.

A third gap 245 is formed between the first engaging portion 231 of the fixed portion floor joint extruding member 211 and the fourth engaging portion 273 of the variable portion floor joint extruding member 251.

A fourth gap 247 is formed between the second engaging portion 233 of the fixed portion floor joint extruding member 211 and the third engaging portion 271 of the variable portion floor joint extruding member 251.

The third gap 245 and the fourth gap 247 can facilitate loading of the fourth engaging portion 273 on the second engaging portion 233.

The third gap 245 may be formed at a predetermined angle by chamfering the fourth engaging portion 273, and the fourth gap 247 may be formed at a predetermined angle by chamfering the second engaging portion 233.

Referring to FIG. 2, FIG. 3 and FIG. 4, in an exemplary embodiment of the present disclosure, the side joint unit 310 is configured to connect the fixed portion side structure 11 of the front body module 10 and the variable portion side structure 41 of the rear body module 40 along the front-to-back direction of the vehicle body.

The side joint unit 310 may connect the fixed portion pillar assembly 13 of the fixed portion side structure 11 and the variable portion pillar assembly 43 of the variable portion side structure 41 along the front-to-back direction of the vehicle body.

The side joint unit 310 may be manufactured as an aluminum extruding member formed by an aluminum extrusion molding method.

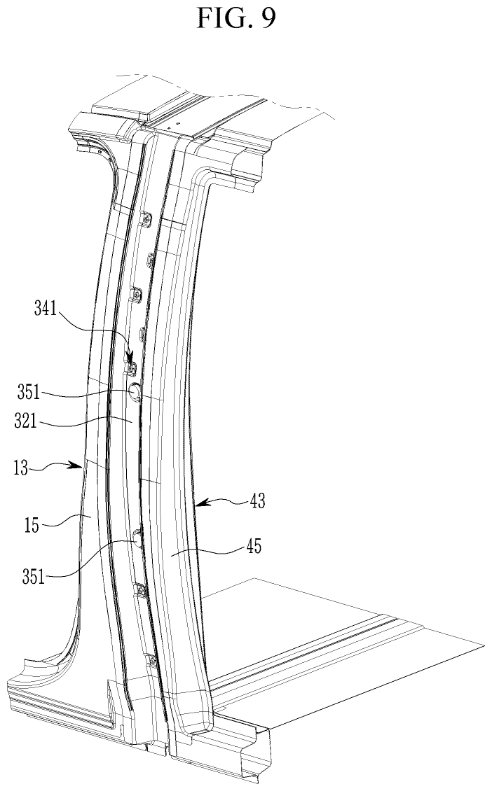

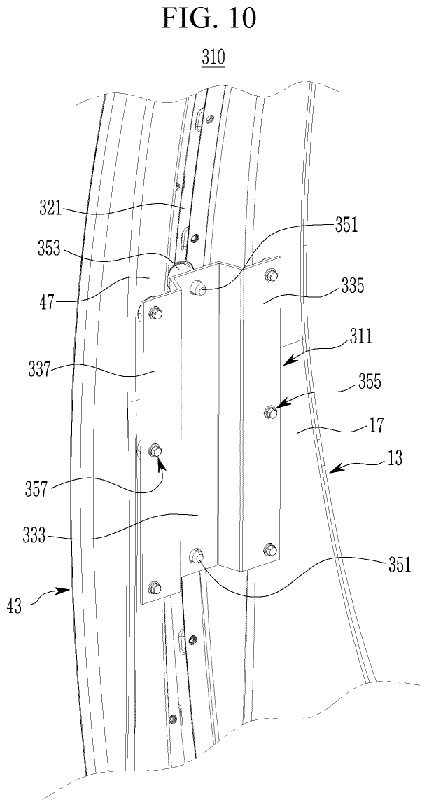

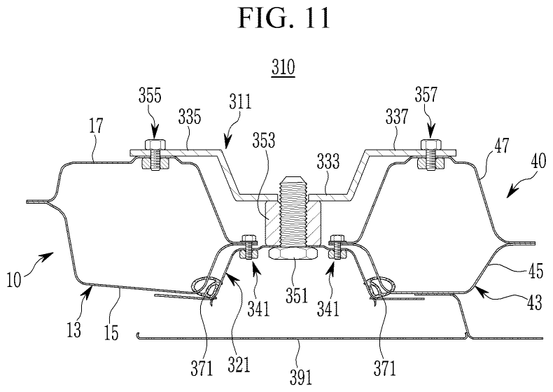

FIG. 9 and FIG. 10 are perspective views exemplarily illustrating a side joint unit applied to the joint structure of a vehicle body according to an exemplary embodiment of the present disclosure, and FIG. 11 is a cross-sectional view exemplarily illustrating the side joint unit applied to the joint structure of a vehicle body according to an exemplary embodiment of the present disclosure.

Referring to FIG. 9, FIG. 10 and FIG. 11, the side joint unit 310 according to an exemplary embodiment of the present disclosure includes a side internal joint extruding member 311.

The side internal joint extruding member 311 engages with a side external joint member 321 of steel material connecting the external sides of the fixed portion pillar assembly 13 and the variable portion pillar assembly 43.

The side internal joint extruding member 311 may connect the internal sides of the fixed portion pillar assembly 13 and the variable portion pillar assembly 43 along the front-to-back direction of the vehicle body.

The fixed portion pillar assembly 13 includes a fixed portion external pillar member 15 and a fixed portion internal pillar member 17 joined together along the vehicle width direction. The variable portion pillar assembly 43 includes a variable portion external pillar member 45 and a variable portion internal pillar member 47 joined together along the vehicle width direction.

The side external joint member 321 of steel material is disposed along the vertical direction between the fixed portion external pillar member 15 and the variable portion external pillar member 45.

The side external joint member 321 engages with a junction area of the fixed portion external pillar member 15 and the fixed portion internal pillar member 17, and a junction area of the variable portion external pillar member 45 and the variable portion internal pillar member 47 through a fastening member 341. The fastening member 341 may include a combination of a bolt and a nut.

The side internal joint extruding member 311 is disposed in the vertical direction between the fixed portion internal pillar member 17 and the variable portion internal pillar member 47. The side internal joint extruding member 311 may be placed adjacent to the belt line of the fixed portion side structure 11 and the variable portion side structure 41 (see FIG. 4).

The side internal joint extruding member 311 may engage with the side external joint member 321 and engage with the fixed portion internal pillar member 17 and the variable portion internal pillar member 47. In one example, the side internal joint extruding member 311 is provided as an aluminum extruding member and may be provided in a plate shape.

The side internal joint extruding member 311 includes a center engaging portion 333, a front engaging portion 335, and a rear engaging portion 337.

The center engaging portion 333 engages with the side external joint member 321. The center engaging portion 333 and the side external joint member 321 may be engaged by an engaging bolt 351.

The engaging bolt 351 may penetrate the side external joint member 321 and engage with a weld nut 353 provided in the center engaging portion 333.

The front engaging portion 335 extends forward from the center engaging portion 333 and engages with the fixed portion internal pillar member 17. The front engaging portion 335 and the fixed portion internal pillar member 17 are engaged through a fastening member 355. The fastening member 355 may include a combination of a bolt and a nut.

The rear engaging portion 337 extends rearward from the center engaging portion 333 and engages with the variable portion internal pillar member 47. The rear engaging portion 337 and the variable portion internal pillar member 47 are engaged via a fastening member 357. The fastening member 357 may include a combination of a bolt and a nut.

The joint structure 100 of a vehicle body further includes a weather strip 371 and a side molding member 391.

The weather strip 371 and the side molding member 391 are configured to seal between the fixed portion pillar assembly 13 and the variable portion pillar assembly 43.

The weather strip 371 is mounted between the fixed portion external pillar member 15 and the side external joint member 321, and between the variable portion external pillar member 45 and the side external joint member 321.

The weather strip 371 may block water inflow between the fixed portion pillar assembly 13 and the variable portion pillar assembly 43.

The side molding member 391 is configured to seal and finish the space between the fixed portion pillar assembly 13 and the variable portion pillar assembly 43.

The side molding member 391 may be mounted between the fixed portion pillar assembly 13 and the variable portion pillar assembly 43, with the side external joint member 321 located on the internal side thereof.

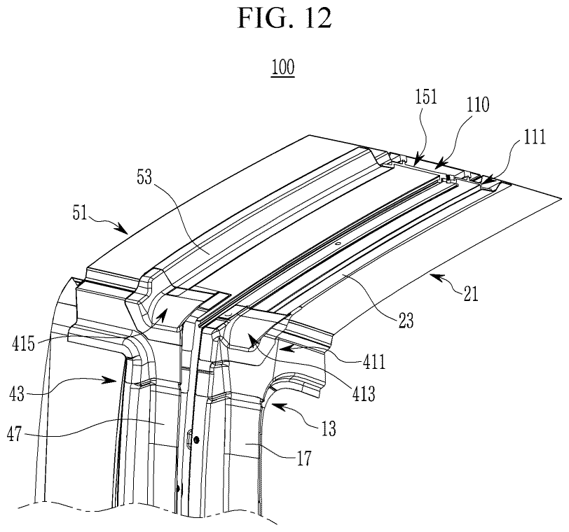

FIG. 12 is a drawing showing a reinforcing unit applied to the joint structure of a vehicle body according to an exemplary embodiment of the present disclosure.

As shown in FIG. 12, the joint structure 100 of a vehicle body further includes a reinforcing unit 411.

The reinforcing unit 411 is configured to reinforce the connection strength between the fixed portion pillar assembly 13 and the fixed portion roof structure 21, and the connection strength between the variable portion pillar assembly 43 and the variable portion roof structure 51.

The reinforcing unit 411 includes a fixed portion gusset member 413 and a variable portion gusset member 415.

The fixed portion gusset member 413 may connect the fixed portion internal pillar member 17 and the fixed portion roof rail 23. The fixed portion gusset member 413 is connected to the fixed portion internal pillar member 17 and the fixed portion roof rail 23.

The fixed portion gusset member 413 is connected to the fixed portion roof joint extruding member 111 of the roof joint unit 110. The fixed portion gusset member 413 may be engaged with the fixed portion roof joint extruding member 111 by the mechanical junction method mentioned above.

The variable portion gusset member 415 may connect the variable portion internal pillar member 47 and the variable portion roof rail 53. The variable portion gusset member 415 is connected to the variable portion internal pillar member 47 and the variable portion roof rail 53.

The variable portion gusset member 415 is connected to the variable portion roof joint extruding member 151 of the roof joint unit 110. The variable portion gusset member 415 may be engaged with the variable portion roof joint extruding member 151 by the mechanical junction method mentioned above.

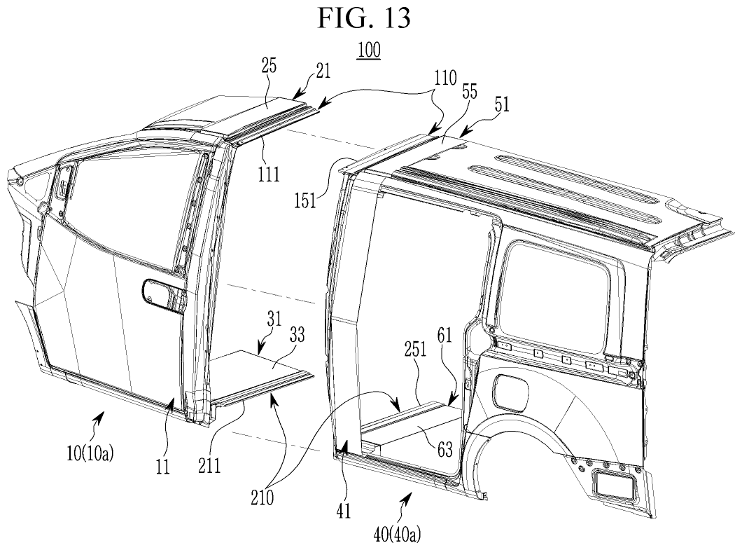

FIG. 13 is a drawing for explaining the assembly process of the joint structure of a vehicle body according to an exemplary embodiment of the present disclosure.

Referring to FIG. 1 to FIG. 13, the assembly process and operation of the joint structure 100 of a vehicle body according to an exemplary embodiment will be described in detail.

The underbody 1 of the vehicle body is provided.

As the upper body 3 to be assembled to the under body 1, the front body module 10 and the rear body module 40 are provided.

The front body module 10 includes the fixed portion side structure 11, the fixed portion roof structure 21, and the fixed portion floor structure 31. The rear body module 40 includes the variable portion side structure 41, the variable portion roof structure 51, and the variable portion floor structure 61.

In the front body module 10, the fixed portion roof joint extruding member 111 of the roof joint unit 110 is engaged with the fixed portion roof rail 23 and the fixed portion roof panel 25 of the fixed portion roof structure 21.

The fixed portion center joint section 131 of the fixed portion roof joint extruding member 111 is engaged with the fixed portion roof panel 25, and the fixed portion front joint section 133 is engaged with the fixed portion roof rail 23.

In the front body module 10, the fixed portion floor joint extruding member 211 of the floor joint unit 210 is engaged with the fixed portion floor panel 33 of the fixed portion floor structure 31. The first engaging portion 231 of the fixed portion floor joint extruding member 211 is engaged with the fixed portion floor panel 33.

In the rear body module 40, the variable portion roof joint extruding member 151 of the roof joint unit 110 is engaged with the variable portion roof rail 53 and the variable portion roof panel 55 of the variable portion roof structure 51.

The variable portion center joint section 171 of the variable portion roof joint extruding member 151 is engaged with the variable portion roof panel 55, and the variable portion rear joint section 173 is engaged with the variable portion roof rail 53.

Additionally, the variable portion floor joint extruding member 251 of the floor joint unit 210 is engaged with the variable portion floor panel 63 of the variable portion floor structure 61. The third engaging portion 271 of the variable portion floor joint extruding member 251 is engaged with the variable portion floor panel 63.

In the present state, the front body module 10 is connected to the front portion of the under body 1 along the vertical direction thereof. The front body module 10 may be provided as the fixed portion 10a which is fixed to the front portion of the under body 1 by a vehicle body mounting unit.

Accordingly, the rear body module 40 including various shapes depending on the intended use is connected along the vertical direction to the rear portion of the under body 1. The rear body module 40 may be provided as the variable portion 40a connected to the rear portion of the under body 1 by a vehicle body mounting unit.

In the present process, the variable portion front joint section 175 of the variable portion roof joint extruding member 151 is loaded on the fixed portion rear joint section 135 of the fixed portion roof joint extruding member 111.

The variable portion front joint section 175 may be easily loaded onto the fixed portion rear joint section 135 by the first gap 145 between the fixed portion center joint section 131 and the variable portion front joint section 175, and the second gap 147 between the fixed portion rear joint section 135 and the variable portion reinforcement rib 179.

The fourth engaging portion 273 of the variable portion floor joint extruding member 251 is loaded on the second engaging portion 233 of the fixed portion floor joint extruding member 211.

By the third gap 245 between the first engaging portion 231 and the fourth engaging portion 273, and the fourth gap 247 between the second engaging portion 233 and the third engaging portion 271, the fourth engaging portion 273 may be easily loaded on the second engaging portion 233.

The variable portion front joint section 175 and the fixed portion rear joint section 135 are engaged by the engaging bolt 141. The fourth engaging portion 273 and the second engaging portion 233 are engaged by the engage bolt 241.

The fixed portion roof structure 21 of the front body module 10 and the variable portion roof structure 51 of the rear body module 40 may be connected along the front-to-back direction of the vehicle body by the roof joint unit 110.

The fixed portion floor structure 31 of the front body module 10 and the variable portion floor structure 61 of the rear body module 40 may be connected along the front-to-back direction of the vehicle body by the floor joint unit 210.

The side external joint member 321 of steel material is provided, and the side internal joint extruding member 311 is provided. The side internal joint extruding member 311 includes the center engaging portion 333, the front engaging portion 335, and the rear engaging portion 337.

The side external joint member 321 is engaged with the junction portion of the fixed portion pillar assembly 13 and the junction portion of the variable portion pillar assembly 43 through the fastening member 341.

The weather strip 371 is mounted between each of the fixed portion external pillar member 15 of the fixed portion pillar assembly 13 and the variable portion external pillar member 45 of the variable portion pillar assembly 43 and the side external joint member 321.

The center engaging portion 333 of the side internal joint extruding member 311 engages with the side external joint member 321 via the engaging bolt 351.

The front engaging portion 335 of the side internal joint extruding member 311 engages with the fixed portion internal pillar member 17 through the fastening member 355, and the rear engaging portion 337 engages with the variable portion internal pillar member 47 through the fastening member 357.

Accordingly, the fixed portion pillar assembly 13 of the front body module 10 and the variable portion pillar assembly 43 of the rear body module 40 may be connected along the front-to-back direction of the vehicle body by the side external joint member 321 and the side internal joint extruding member 311.

The fixed portion gusset member 413 is connected to the fixed portion internal pillar member 17 and the fixed portion roof rail 23, and engages with the fixed portion roof joint extruding member 111. The variable portion gusset member 415 is connected to the variable portion internal pillar member 47 and the variable portion roof rail 53, and engages with the variable portion roof joint extruding member 151.

The roof molding member 181 is connected to the fixed portion molding joint rib 137 formed in the fixed portion center joint section 131 of the fixed portion roof joint extruding member 111, and connected to the variable portion molding joint rib 177 formed in the variable portion center joint section 171 of the variable portion roof joint extruding member 151. The roof molding member 181 is connected to the fixed portion molding joint rib 137 and the variable portion molding joint rib 177 through the watertight pad 183.

The side molding member 391 is mounted between the fixed portion pillar assembly 13 and the variable portion pillar assembly 43, with the side external joint member 321 placed on the internal side thereof.

According to the joint structure 100 of a vehicle body according to an exemplary embodiment of the present disclosure, the front body module 10 as the fixed portion 10a connected to the front portion of the under body 1 may be left as is, and the rear body module 40 as the variable portion 40a may be connected to the rear portion of the under body 1 and the front body module 10.

Therefore, the joint structure 100 of a vehicle body according to an exemplary embodiment can replace the rear body module 40 of a predetermined shape according to the type of customized service (e.g., use case) of the PBV.

Accordingly, the joint structure 100 of a vehicle body according to an exemplary embodiment can easily change the structure of the upper body 3 of the vehicle body depending on the purpose of use of the PBV, and the manufacturing cost of the PBV may be reduced.

Furthermore, according to the joint structure 100 of a vehicle body according to an exemplary embodiment of the present disclosure, the roof joint unit 110, the floor joint unit 210, and the side joint unit 310 connecting the front body module 10 and the rear body module 40 are made of aluminum extruding.

Accordingly, the joint structure 100 of a vehicle body according to various exemplary embodiments of the present disclosure may promote weight reduction of the PBV.

Furthermore, the joint structure 100 of a vehicle body according to an exemplary embodiment of the present disclosure includes the fixed portion reinforcement rib 139 and the variable portion reinforcement rib 179 formed in the roof joint unit 110.

Additionally, according to an exemplary embodiment of the joint structure 100 of a vehicle body, in the floor joint unit 210, the fixed portion floor joint extruding member 211 includes the fixed portion closed cross-section 235, and the variable portion floor joint extruding member 251 includes the variable portion closed cross-section 275.

And, according to an exemplary embodiment of the present disclosure, the joint structure 100 of a vehicle body includes the reinforcing unit 411, the fixed portion gusset member 413 and the variable portion gusset member 415.

Therefore, the joint structure 100 of a vehicle body according to various exemplary embodiments of the present disclosure may secure the joint strength and connection robustness of the front body module 10 and the rear body module 40.

Furthermore, the joint structure 100 of a vehicle body according to an exemplary embodiment of the present disclosure includes the roof molding member 181 connected to the fixed portion molding joint rib 137 and the variable portion molding joint rib 177 via the watertight pad 183.

Additionally, the joint structure 100 of a vehicle body according to an exemplary embodiment of the present disclosure includes the roof molding member 181 that seals between the fixed portion roof structure 21 of the front body module 10 and the variable portion roof structure 51 of the rear body module 40.

And, the joint structure 100 of a vehicle body according to an exemplary embodiment of the present disclosure includes the side molding member 391 that seals between the fixed portion pillar assembly 13 and the variable portion pillar assembly 43.

Therefore, the joint structure 100 of a vehicle body according to an exemplary embodiment can secure the watertight performance of the PBV.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A joint structure of a vehicle body, the joint structure comprising:
a front body module as a fixed portion fixed to a front portion of an under body;
a rear body module as a variable portion detachable to a rear portion of the under body and the front body module in a predetermined shape;
a roof joint unit made of an aluminum extruding member and connecting a fixed portion roof structure of the front body module and a variable portion roof structure of the rear body module; and
a floor joint unit made of an aluminum extruding member and connecting a fixed portion floor structure of the front body module and a variable portion floor structure of the rear body module.

2. The joint structure of claim 1, wherein the roof joint unit includes:
a fixed portion roof joint extruding member that engages with a fixed portion roof rail and a fixed portion roof panel of the fixed portion roof structure connected to each other; and
a variable portion roof joint extruding member that engages with a variable portion roof rail and a variable portion roof panel of the variable portion roof structure connected to each, and is connected to the fixed portion roof joint extruding member.

3. The joint structure of claim 2, wherein the fixed portion roof joint extruding member includes:
a fixed portion center joint section engaged with the fixed portion roof panel;
a fixed portion front joint section extending forward from the fixed portion center joint section and engaged with the fixed portion roof rail; and
a fixed portion rear joint section extending rearward from the fixed portion center joint section and engaged with the variable portion roof joint extruding member.

4. The joint structure of claim 3, wherein the fixed portion roof joint extruding member further includes a fixed portion molding joint rib formed on the fixed portion center joint section.

5. The joint structure of claim 3, wherein the fixed portion roof joint extruding member further includes a fixed portion reinforcement rib formed on the fixed portion rear joint section.

6. The joint structure of claim 3, wherein the variable portion roof joint extruding member includes:
a variable portion center joint section engaged with the variable portion roof panel;
a variable portion rear joint section extending rearward from the variable portion center joint section and engaged with the variable portion roof rail; and
a variable portion front joint section extending forward from the variable portion center joint section and engaged with the fixed portion rear joint section.

7. The joint structure of claim 6, wherein the variable portion roof joint extruding member further includes a variable portion molding joint rib formed on the variable portion center joint section.

8. The joint structure of claim 6, wherein the variable portion roof joint extruding member further includes a variable portion reinforcement rib formed on the variable portion front joint section.

9. The joint structure of claim 8,
wherein a first gap is formed between the fixed portion center joint section and the variable portion front joint section, and
wherein a second gap is formed between the fixed portion rear joint section and the variable portion reinforcement rib.

10. The joint structure of claim 2,
wherein a roof molding member is connected to the fixed portion roof joint extruding member and the variable portion roof joint extruding member, and
wherein the roof molding member is connected to a fixed portion molding joint rib formed on the fixed portion roof joint extruding member and a variable portion molding joint rib formed on the variable portion roof joint extruding member through a watertight pad.

11. The joint structure of claim 1, wherein the floor joint unit includes:
a fixed portion floor joint extruding member engaged with a fixed portion floor panel of the fixed portion floor structure; and
a variable portion floor joint extruding member engaged with a variable portion floor panel of the variable portion floor structure and engaged with the fixed portion floor joint extruding member.

12. The joint structure of claim 11, wherein the fixed portion floor joint extruding member includes:
a first engaging portion that engages with the fixed portion floor panel and forms a fixed portion closed cross-section; and
a second engaging portion which extends rearward from the first engaging portion and engages with the variable portion floor joint extruding member.

13. The joint structure of claim 12, wherein the variable portion floor joint extruding member includes:
a third engaging portion that engages with the variable portion floor panel and forms a variable portion closed cross-section; and
a fourth engaging portion that extends forward from the third engaging portion and engages with the second engaging portion.

14. The joint structure of claim 13, wherein a third gap is formed between the first engaging portion and the fourth engaging portion, and a fourth gap is formed between the second engaging portion and the third engaging portion.

15. A joint structure of a vehicle body, the joint structure comprising:
a front body module as a fixed portion fixed to a front portion of an under body;
a rear body module as a variable portion detachable to a rear portion of the under body and the front body module in a predetermined shape;
a roof joint unit connecting a fixed portion roof structure of the front body module and a variable portion roof structure of the rear body module;
a floor joint unit connecting a fixed portion floor structure of the front body module and a variable portion floor structure of the rear body module; and
a side joint unit made of an aluminum extruding member and connecting a fixed portion pillar assembly of the front body module and a variable portion pillar structure of the rear body module.

16. The joint structure of claim 15, wherein the side joint unit includes a side internal joint extruding member engaged with a side external joint member of steel material connecting external sides of the fixed portion pillar assembly and a variable portion pillar assembly, and connecting internal sides of the fixed portion pillar assembly and the variable portion pillar assembly.

17. The joint structure of claim 16, wherein the side internal joint extruding member includes:
a center engaging portion engaged with the side external joint member;
a front engaging portion extending forward from the center engaging portion and engaged with a fixed portion internal pillar member of the fixed portion pillar assembly; and
a rear engaging portion extending rearward from the center engaging portion and engaged with a variable portion internal pillar member of the variable portion pillar assembly.

18. The joint structure of claim 16, wherein a weather strip is mounted between a fixed portion external pillar member of the fixed portion pillar assembly and the side external joint member, and between a variable portion external pillar member of the variable portion pillar assembly and the side external joint member.

19. The joint structure of claim 15,
wherein a fixed portion internal pillar member of the fixed portion pillar assembly and a fixed portion roof rail of the fixed portion roof structure are connected through a fixed portion gusset member, and
wherein a variable portion internal pillar member of the variable portion pillar assembly and a variable portion roof rail of the variable portion roof structure are connected through a variable portion gusset member.
